(19) United States
(12) Patent Application Publication
(10) Pub. No.: US 2007/0236915 A1
(43) Pub. Date: Oct. 11, 2007

(54) LED FLICKERING SHOES

(76) Inventor: Deen CHEN, Nanan (CN)

Correspondence Address: BANGER SHIA, 204 CANYON CREEK, VICTORIA, TX, 77901-3695, US

(21) Appl. No.: 11/278,958

(22) Filed: Apr. 6, 2006

(51) Int. Cl. F21V 21/08

(52) U.S. Cl. 362/103

(57) ABSTRACT

The present invention provides LED flickering shoes, which typically include a battery cell, a switch, a control circuit, a set of LED illuminators and cords, wherein said LED illuminators are mounted on the instep of the shoes body. Said LED flickering shoes gives out better flashing effect.

### BACKGROUND OF THE INVENTION

1. Field of the Invention

The present invention relates to LED flickering shoes.

2. Description of Prior Art

In accordance with the conventional technology, the LED flickering shoes are varieties of form, and also in structure. But most of them are embedded the LED illuminators 1′ in the sole 2′, as shown in FIG. 1 and FIG. 2, and affected by the vision, they are usually not found easily, so the flickering effect always is counterbalanced with expectation; and said illuminators 1′ used in the flickering shoes are in column subject whatever the conventional bulb or LED, so that the column illuminators 1′ not only loose in located place during using, but also fall out from the location hole not facilitating to firmly retain on the sole 2′, more inconveniently to locate on the soft flexible instep, further to affect to mount them on the instep. So until so far, there is not any flickering shoes located with illuminators 1′ on the instep coming out.

Therefore, it is the goal aimed to by discovering the present invention.

### OBJECTS AND SUMMARY OF THE INVENTION

It is therefore a main object of the present invention to provide a LED flickering shoes having better flickering effect.

It is a next object of the present invention to provide a LED flickering shoes with high efficiency, long service time and strong attractive sense features.

For achieving the above-mentioned objects, the present invention provides the technology as follows: a LED flickering shoes typically includes a battery cell, a switch, a control circuit, a set of LED illuminators and cords, wherein said LED illuminators are mounted on the instep of the shoes body.

Said LED illuminators are surface-mount LED for facilitating to mounting on the flexible instep of the shoes body and occupying smaller volume without affecting the conformability.

Said cords connecting the control circuit to the LED illuminators are soft multi-strand cords facilitating to locating in any where in the shoes body, so that it can keep the LED illuminators in connection even if some strands are located in the soft instep or broken off in use.

Said control circuit drives to light the LED illuminators according to pre-set program to make them create variable imaging effect with pulse form driving power as cutting on the switch, it not only delays the service time of the battery cells, but also postpones aging resistance time of LED illuminators.

Said control circuit is super-integrated circuit with low dissipation, high reliability and smooth working state.

Said battery cell is 3.0 V button cell with low cost, smaller thinness and easy mount.

Said battery cell, switch and control circuit are integrated into a plastic box, the gaps between the shells and all the parts are filled with high hardness resin to anti-press and to anti-water avoiding the parts damaging to postpone the service life of the flickering shoes.

Said assembly is mounted in the heel portion of the sole, and the LED illuminators connected with conductors are mounted on the front and both sides and back including upper portion and instep for improving beautiful sense.

Said switch is an acoustic switch.

Said switch is a vibro-switch.

Utilizing above-mentioned structure, in the present invention, due to the LED illuminators mounted on the instep of the shoes, the light emitted is easy to be obviously seen, so the goods provided by the present invention have better flickering effect than conventional.

### BRIEF DESCRIPTION OF THE DRAWINGS

FIG. 1 is a scheme of the prior art.

FIG. 2 is a top-side sectional view of the prior art.

FIG. 3 is a scheme showing the embodiment of the present invention.

FIG. 4 is a scheme showing the surface-mount LED illuminator.

FIG. 5 is a scheme showing the assembly of the present invention.

FIG. 6 is a block schematic circuit of the present invention.

FIG. 7 is a pulse form diagram showing the pulse signal of the present invention.

FIG. 8 is a scheme showing the assembly located in shoes body state of the present invention.

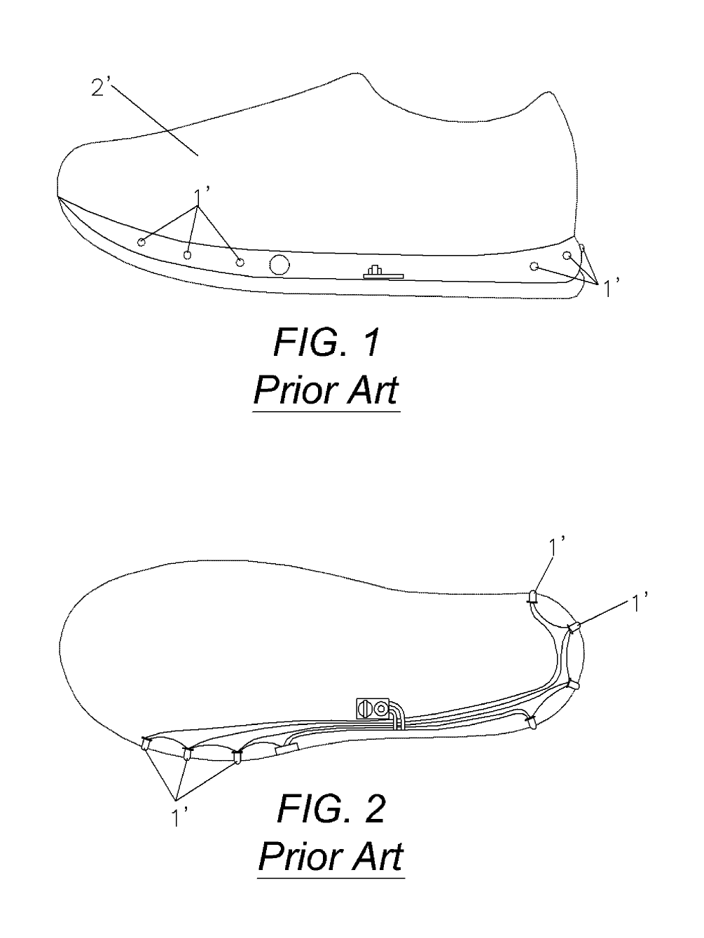

### DETAILED DESCRIPTION OF PREFERRED EMBODIMENTS

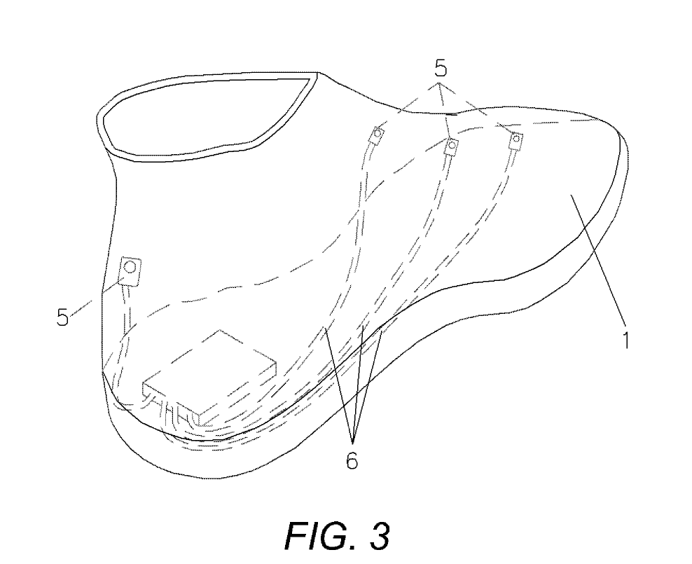

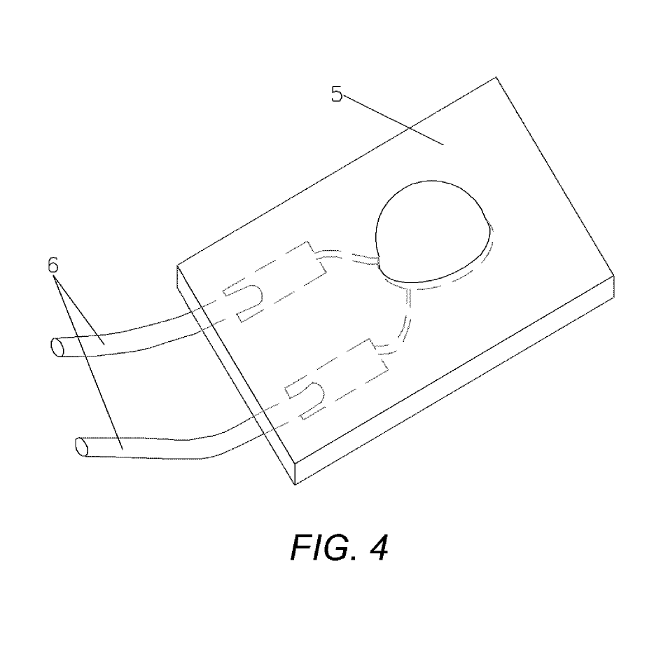

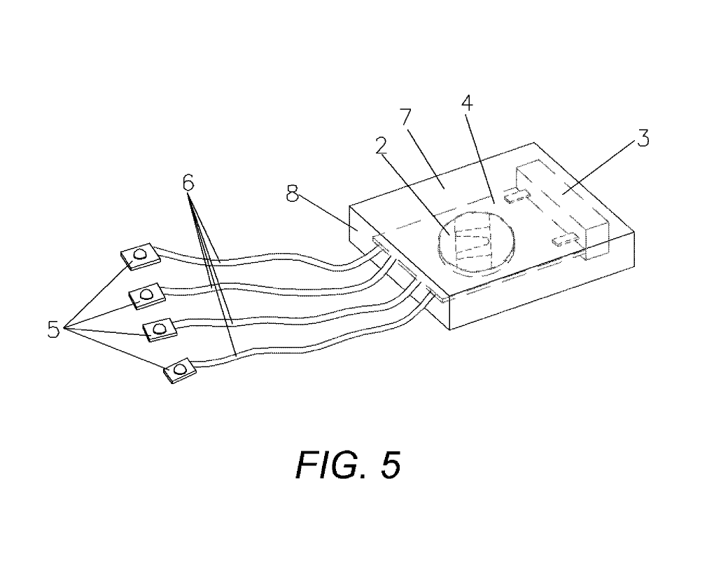

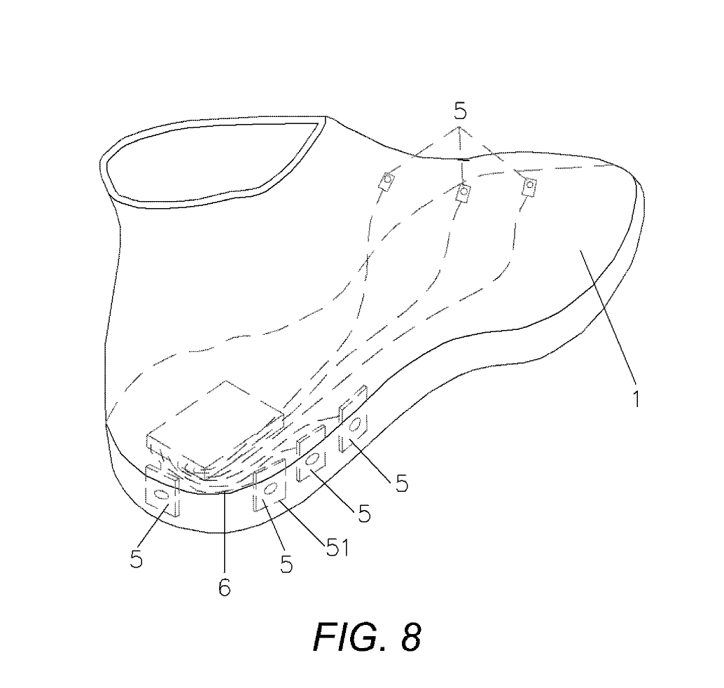

Referring to FIG. 3, LED flickering shoes discovered by the present invention is typically comprised of shoes body 1 and flickering assembly (as shown in FIG. 5) embedded into the shoes body 1 including a battery cell 2, a switch 3, a control circuit 4, proper number of LED illuminators 5 and cords 6. The vital feature is that said LED illuminators 5 are mounted on the instep of the shoes, thereby emitting obvious light for getting better flickering effect.

Wherein, referring to FIG. 4, said LED illuminator 5 is surface-mount LED selected, thereby embedding into vertical retaining holes set upon the sole and being retaining in it firmly by sewing up the instep on the sole in manufacturing without any falling off (cooperating to refer to FIG. 8), and facilitating to mounting on the surface of the soft instep occupying smaller space so that the stitched instep is in flat and beauty look without any uncomfortable feel as wearing.

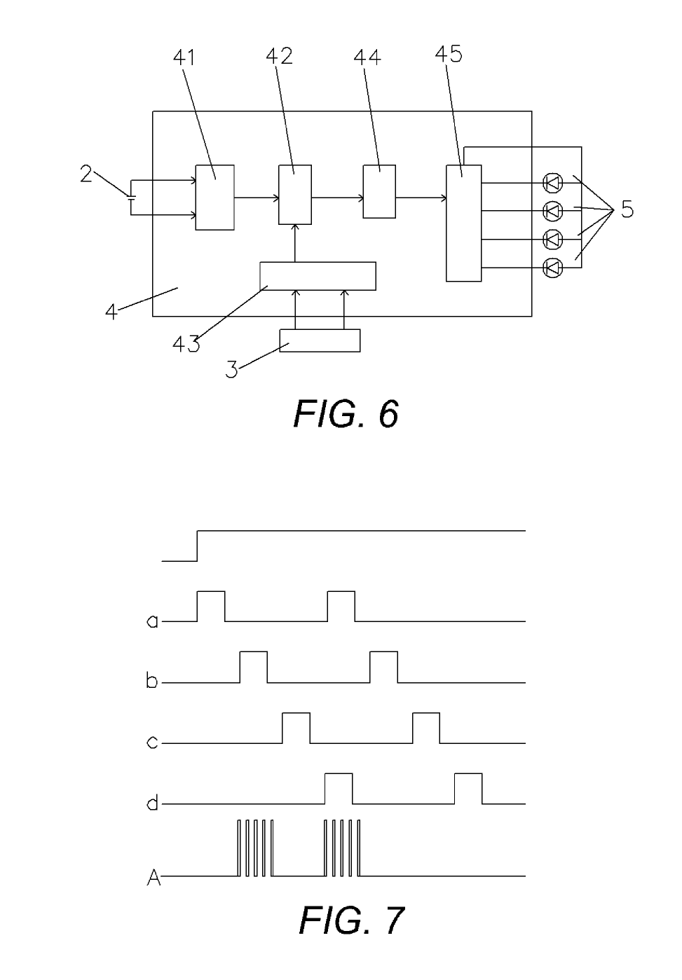

Referring to FIG. 5, it is showing the embodiment, in which said battery cell 2, switch 3 and control circuit 4 are integrated into a plastic box 7, the gaps between the shells 7 and all the parts located in the inside of the shells 7 are filled with high hardness resin to anti-press and to anti-water avoiding the parts damaging to postpone the service life of the flickering shoes. Wherein said battery cell 2 is 3.0V button cell adopted with low cost, smaller thinness and easy mount. Said switch 3 is an acoustic or a vibro switch. Said control circuit 4 is super-integrated circuit that is typically integrated of power supervisor 41, coordinated controller 42, shock pick-up 43, pulse signal generator 44 and output signal distributor 45. Said control circuit 4 drives to light the LED illuminators 5 according to pre-set program to make them create variable imaging effect with pulse form driving power as cutting on the switch 3, it not only delays the service time of the battery cells, but also postpones aging resistance time of LED illuminators 5. Taking vibro-switch for example, FIG. 6 is showing the working principle, in general, said power supervisor 41 only supplies power to the shock pick-up 43 so as to output a signal, when some vibration is picked up by cutting on the vibro-switch 3, to the coordinated controller 42 to trigger the pulse signal generator 44 giving out pulse signal to the signal distributor 45, therein the output ports are sequentially opened to drive each lined LED illuminators 5, there are four sets of LED illuminators 5 in this embodiment. The output pulse signal form of the signal distributor 45 is shown in FIG. 7, in which the pulse signals a b c d output from the pulse signal generator 44 to the signal distributor 45, and the signal form A output from the signal distributor 45 is applied to drive the LED illuminators 5.

For facilitating to locating the LED illuminators 5 on any where of the shoes body 1, the cords 6 connecting the control circuit 4 to the LED illuminators 5 are soft cords selected for keeping the LED illuminators 5 in normal working state even if any strand of it is broken off in use or in sewing up.

In combination, FIG. 5 is showing the flickering assembly is mounted on the heel portion of the sole of the shoes body 1, and the LED illuminators 5 connected with conductors are mounted on the front and both sides and back including upper portion and instep for improving beautiful sense.

I claim:

1. LED flickering shoes typically including a battery cell, a switch, a control circuit, a set of LED illuminators and cords, wherein said LED illuminators are mounted on the instep of the shoes body.

2. LED flickering shoes as claimed in claim 1, wherein said LED illuminators are surface-mount LED.

3. LED flickering shoes as claimed in claim 1, wherein said cords connecting the control circuit to the LED illuminators are soft multi-strand cords.

4. LED flickering shoes as claimed in claim 1, wherein said control circuit drives to light the LED illuminators according to pre-set program to make them create variable imaging effect with pulse form driving power as cutting on the switch at once.

5. LED flickering shoes as claimed in claim 1, wherein said control circuit is super-integrated circuit.

6. LED flickering shoes as claimed in claim 1, wherein said battery cell is 3.0V button cell.

7. LED flickering shoes as claimed in claim 1, wherein said battery cell, switch and control circuit are integrated into a plastic box, the gaps between the shells and all the parts located at the inside of the shells are filled with high hardness resin.

8. LED flickering shoes as claimed in claim 1, wherein said assembly is mounted in the heel portion of the sole, and the LED illuminators connected with conductors are mounted on the front and both sides and back including upper portion and in-step.

9. LED flickering shoes as claimed in claim 1, wherein said switch is an acoustic switch.

10. LED flickering shoes as claimed in claim 1, wherein said switch is a vibro-switch.
